(19) United States
(12) Patent Application Publication
(10) Pub. No.: US 2018/0312117 A1
(43) Pub. Date: Nov. 1, 2018

(54) METHODS AND SYSTEMS FOR POWERING AND COMMUNICATING WITH A STEERING WHEEL

(71) Applicant: GM GLOBAL TECHNOLOGY OPERATIONS LLC, Detroit, MI (US)

(72) Inventors: YOHAY BUCHBUT, PARDES-HANNA (IL); KOBI SCHEIM, PARDES-HANNA (IL)

(73) Assignee: GM GLOBAL TECHNOLOGY OPERATIONS LLC, Detroit, MI (US)

(21) Appl. No.: 15/499,807

(22) Filed: Apr. 27, 2017

(51) Int. Cl. B60R 16/027; B60R 16/04; B60R 16/023; B62D 65/02

(52) U.S. Cl. CPC B60R 16/027; B62D 65/02; B60R 16/0231; B60R 16/04

(57) ABSTRACT

Motor vehicles and methods for power and communication with a steering wheel are provided. In an exemplary embodiment, a motor vehicle includes a steering wheel, a body, and a wheel shaft rotationally connecting the steering wheel to the body. A body power coil is positioned in the body, where the body power coil includes conductive wire. A wheel power coil is positioned in the steering wheel, where the wheel power coil includes conductive wire. The wheel power coil and the body power coil are separated by a resonance gap, and are configured to transfer electricity by magnetic resonance coupling.

### INTRODUCTION

The technical field generally relates to methods and systems for power transfer and communications between a steering wheel and a motor vehicle, and more particularly relates to methods and systems for wireless power transfer and communications between a steering wheel and a motor vehicle.

Most motor vehicles include a steering wheel that a driver uses to guide the motor vehicle. The steering wheel is attached to a vehicle body with a wheel shaft that rotates as the steering wheel is turned. Many steering wheels also include switches and controls for operating various components in the motor vehicle. For example, some steering wheels include radio and stereo controls, controls for a cruise control, and a horn. These controls operate regardless of the position of the steering wheel. The controls require power for lighting and/or for operations, and some steering wheels include heaters or other devices with a larger power draw. Steering wheels typically include a spiral cable for electrical connections between controls on the steering wheel and the body, where the spiral cable is a hard wired connection. The spiral cable also provides power for operations in the steering wheel. The spiral cable wraps in and out of a housing as the steering wheel is turned, so the radio, stereo and other components can be controlled when the steering wheel is in any position.

The spiral cable and the associated housing are relatively large and heavy, so appropriate space and support mechanisms must be provided in the design of the motor vehicle. The spiral cable tends to wear with the repeated coiling and uncoiling of the spiral cable in the housing as the steering wheel is turned, and this wear contributes to reliability concerns. Furthermore, the spiral cable requires physical connections that can be sources of faults or shorts.

Accordingly, it is desirable to provide methods and systems for eliminating the spiral cable from the steering column. In addition, it is desirable to develop methods and systems for powering and providing communications with the steering wheel without encumbering the steering column with hard wired connections. Furthermore, other desirable features and characteristics of the present invention will become apparent from the subsequent detailed description of the invention and the appended claims, taken in conjunction with the accompanying drawings and the background of the invention.

### SUMMARY

Motor vehicles and methods for power and communication between a motor vehicle body and a steering wheel are provided. In an exemplary embodiment, a motor vehicle includes a steering wheel, a body, and a wheel shaft rotationally connecting the steering wheel to the body. A body power coil is positioned in the body, where the body power coil includes conductive wire. A wheel power coil is positioned in the steering wheel, where the wheel power coil includes conductive wire. The wheel power coil and the body power coil are separated by a resonance gap, and are configured to transfer electricity by magnetic resonance coupling.

A motor vehicle is provided in another embodiment. The motor vehicle includes a steering wheel, a body, and a wheel shaft rotationally connecting the steering wheel to the body. A wheel transceiver is positioned in the steering wheel, and a body transceiver is positioned in the body. The body transceiver and the wheel transceiver are configured to wirelessly communicate with each other.

A method of producing a motor vehicle is provided in yet another embodiment. The method includes attaching a steering wheel to a body, where the body includes a body power coil and the steering wheel includes a wheel power coil. The body power coil and the wheel power coil are configured to transfer electrical power from the body power coil to the wheel power coil by magnetic resonance coupling.

### BRIEF DESCRIPTION OF THE DRAWINGS

The exemplary embodiments will hereinafter be described in conjunction with the following drawing figures, wherein like numerals denote like elements, and wherein:

FIG. 1 illustrates an exemplary motor vehicle;

FIG. 2 illustrates an embodiment with a partially exploded view of a portion of a cabin of a motor vehicle, where a battery and an inverter are shown for illustration purposes;

FIG. 3 is another partially exploded view of a portion of a cabin of an embodiment of the motor vehicle, where a wheel shaft has been removed from the drawing for clarity;

FIGS. 4 and 5 are front and back views of an embodiment of a printed circuit board;

FIG. 6 is a perspective view of an embodiment of a flexible printed circuit board; and

FIGS. 7-10 are schematic drawings of embodiments of a system and method for transferring electricity and communications between a steering wheel and a motor vehicle body.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

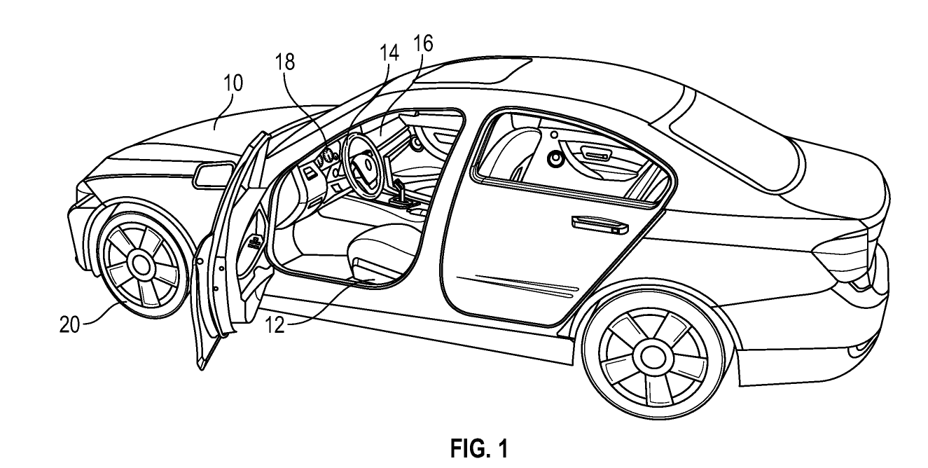

Reference is made to an exemplary embodiment in FIG. 1. A motor vehicle 10 is provided, wherein the motor vehicle 10 has a cabin 12 configured for occupation by people. In an exemplary embodiment, the motor vehicle 10 is an automobile, but other motor vehicles 10 are possible in alternate embodiments, such as an airplane. The cabin 12 includes a steering wheel 14 and a body 16, where the steering wheel 14 is connected to the body 16, typically at or near a dash board 18. The steering wheel 14 is turned to operate a vehicle steering controller 20, where the vehicle steering controller 20 is two front wheels of the motor vehicle 10 in many embodiments. However, in alternate embodiments the vehicle steering controller 20 is a single front wheel (not illustrated), such as for a two or three wheeled motor vehicle, or four wheels such as all wheel steering or special utility vehicles, or ailerons or other components for an airplane, etc. In this description, the “steering wheel” 14 includes the structure that a driver turns to turn the motor vehicle 10, including all the components that spin or turn with that structure up to the point where the spinning structure abuts the body 16 that does not spin for turning the motor vehicle 10, except the connecting wheel shaft 30 is not considered part of the steering wheel 14. The steering wheel 14 is round in an exemplary embodiment, but the steering wheel 14 includes a central connector and handles connected to that central connector in an alternate embodiment (not illustrated, but as seen on some airplanes). Other embodiments of the steering wheel 14 are also possible.

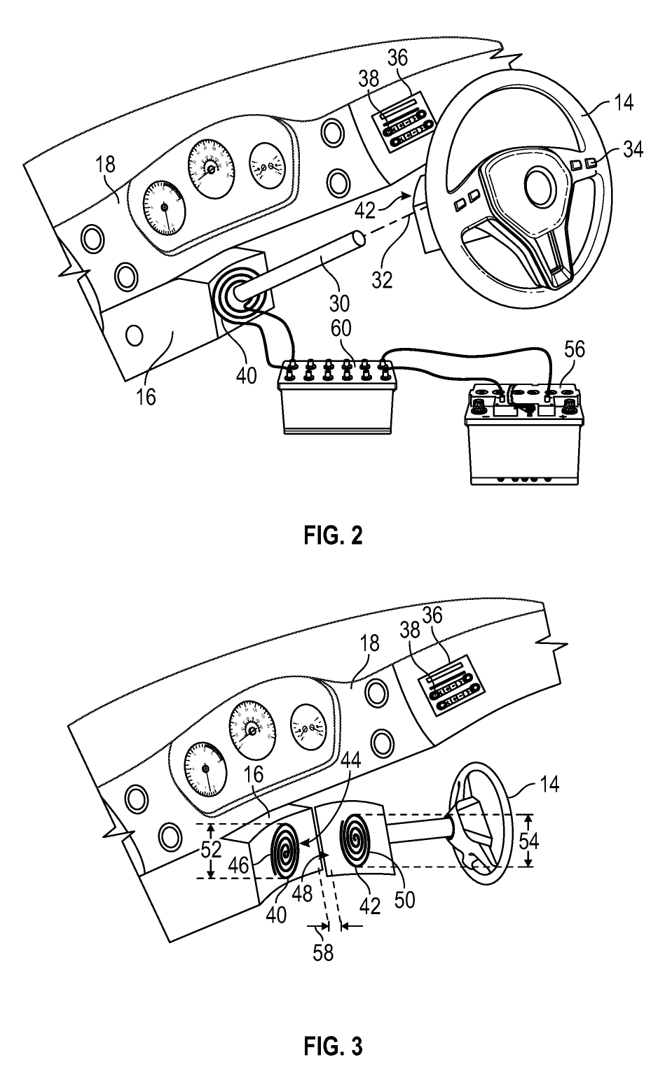

The steering wheel 14 is connected to the body 16 of the motor vehicle 10 by a wheel shaft 30, as illustrated in an exemplary embodiment in FIG. 2 with continuing reference to FIG. 1. The steering wheel 14 is rotationally connected to the body 16 such that the steering wheel 14 can spin or rotate about a steering axis 32 that is aligned with the center of the wheel shaft 30 in the illustrated embodiment. The steering wheel 14 includes one or more wheel actuators 34, where the wheel actuators 34 are configured to send a control signal to a vehicle component 36, such as a radio, a stereo, a cruise control, a guidance system, a steering wheel heater, or other components.

The vehicle component 36 is configured to receive the control signal and to change operations based on the control signal. In an exemplary embodiment where the vehicle component 36 is a stereo, the vehicle component 36 (i.e., the stereo) can adjust the volume, turn on and off, change radio stations, switch between a radio function and a CD function, and/or take other actions based on one or more control signals. Some or all of the control signals for the vehicle component 36 are operated by the wheel actuator(s) 34. In an exemplary embodiment, the vehicle component 36 also includes local actuators 38 positioned on or near the vehicle component 36 that also provide control signals. In the exemplary embodiment where the vehicle component 36 is a stereo, the vehicle component 36 includes a volume control positioned on the stereo, as well as an on/off switch, a radio tuner adjustment knob, and a radio-CD function switch. The driver of the motor vehicle 10 is capable of using either the local actuators 38 or the wheel actuators 34 to send the control signal to the vehicle component 36. In alternate embodiments, the wheel actuator(s) 34 are the only controls for some vehicle components 36, and local actuators 38 are the only controls for other vehicle components 36.

The wheel actuators 34 require electrical power to generate and send the control signal. In an exemplary embodiment, electrical power is transferred to the steering wheel 14 using magnetic resonance coupling. Magnetic resonance coupling is the transfer of electrical power from one conductor (the transmitter) that produces a magnetic field to another conductor (the receiver). In an exemplary embodiment, the alternating current flows through the transmitter conductor and generates a magnetic field builds and crashes with changes in the alternating current. The receiver conductor is typically formed in a coil within the building and crashing magnetic field, where the receiver coil produces electricity as the magnetic field changes. In an exemplary embodiment, the magnetic resonance coupling uses a body power coil 40 positioned within the body 16, and a wheel power coil 42 (not visible in FIG. 2, but indicated by the arrow) positioned within the steering wheel 14, as illustrated in FIG. 3 with continuing reference to FIGS. 1 and 2, where the wheel shaft 30 is not illustrated in FIG. 3 for clarity. The body and wheel power coils 40, 42 each separately include a conductive wire that is wrapped in a repeating pattern to produce a coil. The body coil 40 has a body coil face 44 and a body coil edge 46, and the wheel coil 42 has a wheel coil face 48 and a wheel coil edge 50. The body and wheel coil face 44, 48 is the surface across which the longest dimension of the coil runs, and the coil edge 46, 50 is perpendicular to the coil face 44, 48. In an embodiment with a circular coil, a diameter of the coil is measured across the coil face and a thickness of the coil is measured across the coil edge. A coil typically includes two coil faces opposite each other.

In an exemplary embodiment, the body coil face 44 and the wheel coil face 48 are round, but in alternate embodiments the body coil face 44 and/or the wheel coil face 48 are square, rectangular, oval, or other shapes. A square or rectangular shape for the body and/or wheel coil face 44, 48 can aid in power transfer if the body power coil 40 and wheel power coil 42 are partially mis-aligned. The body and wheel power coils 40, 42 have a body coil maximum distance 52 and a wheel coil maximum distance 54, respectively, where the body and wheel coil maximum distance 52, 54 is the maximum distance measured across the body and wheel coil face 44, 48, respectively. In an embodiment with a round body coil face 44, the body coil maximum distance is the diameter of the body coil face 44. In an embodiment with a square body coil face 44, the body coil maximum distance 52 is the diagonal of the square, and so forth.

The body power coil 40 and the wheel power coil 42 are positioned adjacent to each other, such that the body coil face 44 is positioned adjacent to and at least partially overlapping the wheel coil face 48. Alternating current electricity provided to the body power coil 40 (i.e., a transmitter coil), induces an electrical alternating current in the wheel power coil 42 (i.e., a receiver coil). The wheel power coil 42 and the body power coil 40 are positioned near each other, but are not in electrical communication, wherein “electrical communication,” as used herein, means connected by one or more electrical conductors. As such, no wire, bar, bus, or other electrical conductor contacts both the wheel power coil 42 and the body power coil 40. A resonance gap 58 is the distance between the body power coil 40 and the wheel power coil 42, and the resonance gap 58 is from about more than 0 centimeters to about the lesser of the body coil maximum distance 52 and the wheel coil maximum distance 54 in an exemplary embodiment. In other embodiments, the resonance gap 58 is from about more than 0 centimeters to about ½ or about ¼ of the lesser of the body and wheel coil maximum distance 52, 54. The body and wheel power coils 40, 42 can be as close as possible as long as there is no electrical communication (i.e., an electrical short) between the two. In some embodiments, the body power coil 40 and/or the wheel power coil 42 are positioned concentrically around the wheel shaft 30 and the steering axis 32, but other positions are also possible. The electricity produced in the wheel power coil 42 is used as needed within the steering wheel 14, such as for producing a control signal or for powering a steering wheel heater (not illustrated in FIGS. 1-3).

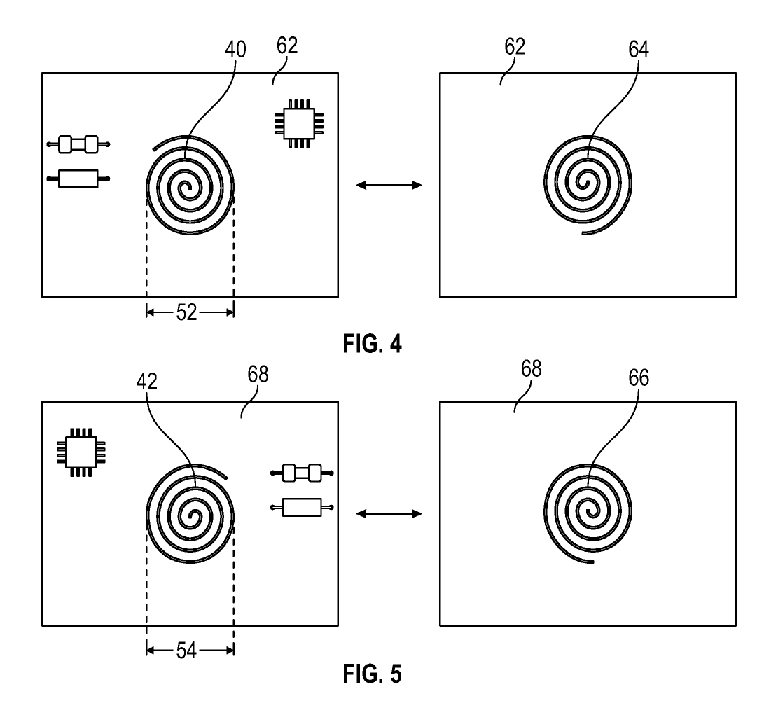

In some embodiments, the body power coil 40 is printed on a body printed circuit board 62, as illustrated in FIG. 4. A body impedance coil 64 is present in some embodiments, where the body impedance coil 64 is used for matching the impendence between the body and wheel power coils 40, 42. The impedance coil 64 is also a coil of electrically conducting wire, as described above for the body power coil 40, and is round, square, oval, or other shapes in various embodiments. The body impedance coil 64 is printed on an opposite side of the body printed circuit board 62 as the body power coil 40 in some embodiments. The body printed circuit board 62 is molded into the body 16 in some embodiments, but the body printed circuit board 62 is a discrete component that is mounted to another part of the body 16 in alternate embodiments. In yet other embodiments, the body power and/or impedance coils 40, 64 are coils of wire that are not printed on a printed circuit board. In some embodiments, both the body power coil 40 and body impedance coil 64 are printed on a separated two-sided board or integrated on one side of the body 16 separated by a nonconductive material such as a flexible plastic sheet. In other embodiments both the body power and body impedance coils 40, 64 are integrated within the body 16 such that both coils 40, 64 are molded inside the body 16 or both coils 40, 64 appear on opposite sides of the body 16. The body impedance coil 64 is mounted within from about 1 body coil maximum distance to more than about 0 centimeters from the body power coil 40 to effectively control the impedance.

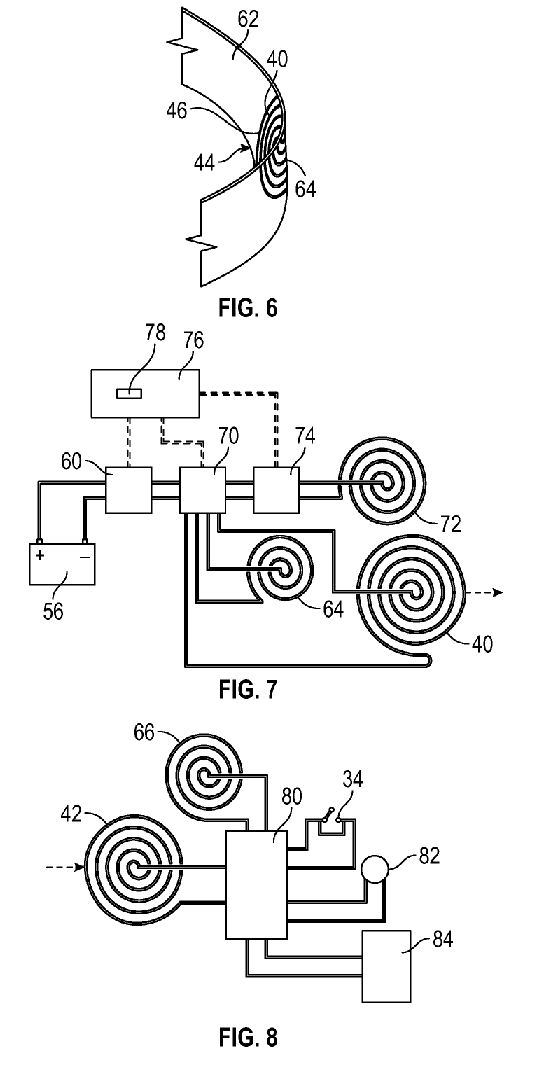

Referring to an exemplary embodiment illustrated in FIG. 5, a wheel impedance coil 66 is printed on a wheel printed circuit board 68 as described above for the body impedance coil 64. As with the body coils 40, 64, zero, one, or both of the wheel power coil 42 and the wheel impedance coil 66 are printed on the wheel printed circuit board 68, where the wheel power and/or impedance coils 42, 66 are independent coils that are not printed on a printed circuit board in alternate embodiments. The wheel impedance coil 66 is used to match the impedance of the body and wheel power coils 40, 42 in conjunction with the body impedance coil 64. The wheel printed circuit board 68 is molded into the steering wheel 14 or it is a separate component that is mounted to the steering wheel 14 in alternate embodiments, as described above for the body printed circuit board 62. In some embodiments, one or both of the body and wheel printed circuit boards 62, 68 are flexible, as illustrated for the body printed circuit board 62 in FIG. 6.

Reference is made to an exemplary embodiment in FIGS. 7 and 8, with continuing reference to FIGS. 1-6, where FIG. 7 schematically represents body components and FIG. 8 schematically represents the steering wheel components. A battery 56 provides direct current electricity to an inverter 60, where the inverter 60 converts the direct current to alternating current. The inverter 60 is available on a circuit board in an exemplary embodiment (not illustrated), but other forms of the inverter are used in alternate embodiments. The alternating current from the inverter 60 flows to a body amplifier 70, where the alternating current is amplified before flowing to the body power coil 40 and the body impedance coil 64. In some embodiments, the control signal produced by the wheel actuators 34 are transferred to the body 16 from the wheel power coil 42, where a communication coil 72 receives the control signals. A body communication board 74 is configured to send the control signal received by the communication coil 72 to the appropriate vehicle component 36. The communication coil 72 is configured to send and/or receive (i.e. transfer) a control signal or other communication signal by modulating a parameter of electrical power in the body power coil 40. For example, the communication coil 72 can modulate frequency, amplitude, phase, change reflected impedance, or other parameters in the body power coil 40.

A body controller 76 is configured to communicate with one or more of the inverter 60, the body amplifier 70, the body communication board 74, and the communication coil 72. In various embodiments, the body controller 76 includes any type of processor or multiple processors, integrated circuits such as a microprocessor, or any suitable number of integrated circuit devices and/or circuitry working in cooperation to accomplish the tasks of the body controller 76. The body controller 76 executes one or more programs that are stored within a body controller memory 78 in an exemplary embodiment. In one example, the body controller memory 78 saves various other data as well, such as information for other processes within the motor vehicle 10. In various embodiments, the body controller 76 includes, or has access to, any type of body controller memory 78, including but not limited to random access memory (RAM), read only memory (ROM), erasable programmable read only memory (EPROM), electrically erasable programmable read only memory (EEPROM), and non-volatile random access memory (NVRAM).

The wheel power coil 42 and the wheel impedance coil 66 are in communication with a wheel controller 80 in an exemplary embodiment illustrated in FIG. 8, with continuing reference to FIGS. 1-7, where magnetic resonance flux from the body power coil 40 is received by the wheel power coil 42 to produce alternating current electricity. The wheel controller 80 operates on alternating current in an exemplary embodiment, but the wheel controller 80 includes an inverter (not illustrated) to produce direct current for operations in an alternate embodiment. The wheel controller 80 is configured to control electrical operations in the steering wheel 14, such as the wheel actuator 34. The wheel controller 80 is free of an electrical connection with the body because electricity is transferred wirelessly by magnetic resonance coupling, and the control signal is also transferred wirelessly, such as through modulating the magnetic field. The wheel controller 80 is in communication with a wheel actuator 34. In some embodiments, the wheel controller 80 is also in communication with a wheel light 82 and/or a wheel heater 84, where the wheel light 82 produces visible light to aid the driver in operating the motor vehicle 10. The optional wheel heater 84 heats the steering wheel 14 for a more comfortable feel. The wheel controller 80 sends the control signal to the wheel power coil 42, where the control signal is an electrical parameter such as modulations of the frequency, amplitude, phase, or change reflected impedance.

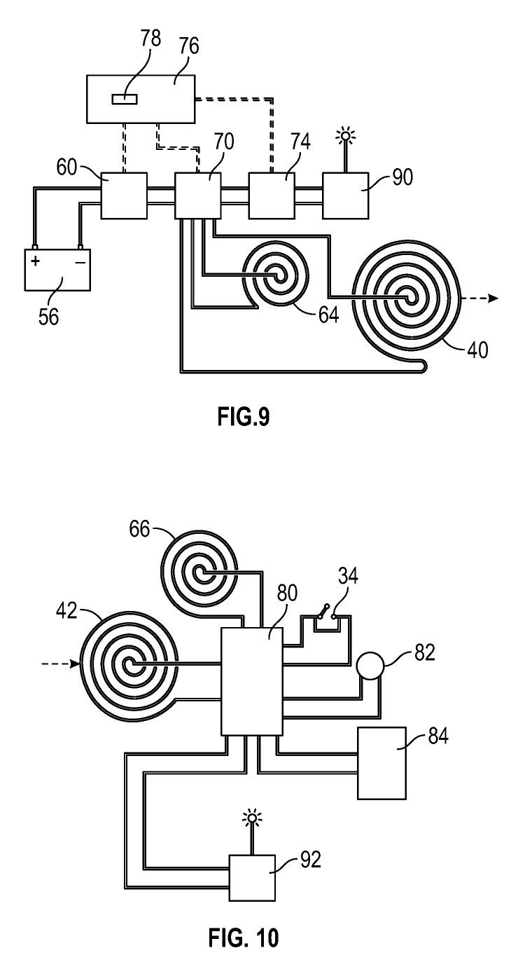

FIGS. 9 and 10 illustrate an alternate embodiment with a body transceiver 90 and wheel transceiver 92 for the control signal, with continuing reference to FIGS. 1-8. The body transceiver 90 is positioned in the body 16, and the wheel transceiver is positioned in the steering wheel 14. The body and wheel transceivers 90, 92 are configured to communicate wirelessly. In an exemplary embodiment, the body and wheel transceivers 90, 92 are configured to communicate with visible light, but in alternate embodiments other types of communication are used. In one embodiment, the body and wheel transceivers 90, 92 are configured to communicate with a short range radio frequency protocol. For example, the communication protocol associated with the trademark BLUETOOTH® is used in some embodiments. The operations and components for the magnetic resonance coupling are as described above.

The use of magnetic resonance coupling and wireless communication systems eliminate the need for a spiral cable or another hard wired electrical connector between the body 16 and the steering wheel 14, so the motor vehicle 10 is free of a steering wheel power wire (not illustrated) or a steering wheel signal wire (not illustrated) that travel from the body 16 to the steering wheel 14. The wireless transfer of power and control signals reduces the number of moving parts in the steering wheel system compared to a steering wheel with a spiral cable. The reduction in the number moving parts can improve reliability and simplicity while reducing weight and bulk. Many of the components for the magnetic resonance coupling and the wireless communication are available on circuit boards of one type or another, and circuit boards typically require less space and weight than a spiral cable and the associated hardware. Therefore, the wireless transfer of power and communications also reduces bulk and weight in many embodiments.

While at least one exemplary aspect has been presented in the foregoing detailed description, it should be appreciated that a vast number of variations exist. It should also be appreciated that the exemplary aspect or exemplary aspects are only examples, and are not intended to limit the scope, applicability, or configuration of the invention in any way. Rather, the foregoing detailed description will provide those skilled in the art with a convenient road map for implementing an exemplary aspect of the invention. It is to be understood that various changes may be made in the function and arrangement of elements described in an exemplary aspect without departing from the scope of the invention as set forth in the appended claims.

What is claimed is:

1. A motor vehicle comprising:
a steering wheel;
a body;
a wheel shaft connected to the steering wheel and to the body such that the steering wheel is rotationally connected to the body;
a body power coil positioned in the body, wherein the body power coil comprises conductive wire; and
a wheel power coil positioned in the steering wheel, wherein the wheel power coil comprises conductive wire, wherein the body power coil is separated from the wheel power coil by a resonance gap, and wherein the wheel power coil and the body power coil are configured to transfer electricity by magnetic resonance coupling.

2. The motor vehicle of claim 1 wherein the body power coil is positioned concentrically around the wheel shaft.

3. The motor vehicle of claim 1 further comprising:
a battery positioned with the motor vehicle; and
a direct current to alternating current inverter (DC to AC inverter) in electrical communication with the battery and the body power coil, wherein the DC to AC inverter is configured to convert direct current to alternating current.

4. The motor vehicle of claim 1 wherein the body power coil has a rectangular shape.

5. The motor vehicle of claim 1 wherein the body power coil is printed on a printed circuit board.

6. The motor vehicle of claim 1 further comprising:
a body impedance coil positioned in the body; and
a wheel impedance coil positioned in the steering wheel.

7. The motor vehicle of claim 6 wherein:
the body impedance coil and the body power coil are printed on opposite sides of a body printed circuit board.

8. The motor vehicle of claim 7 wherein the body printed circuit board is embedded in the body.

9. The motor vehicle of claim 7 wherein:
the wheel power coil and the wheel impedance coil are printed on opposite sides of a wheel printed circuit board.

10. The motor vehicle of claim 1 further comprising:
a wheel controller positioned in the steering wheel, wherein the wheel controller is free of an electrical connection with the body, and wherein the wheel controller is configured to control electrical operations in the steering wheel.

11. The motor vehicle of claim 1 further comprising a body communication board in the body, wherein the body communication board is configured to transfer a communication signal through the body power coil.

12. The motor vehicle of claim 1 further comprising:
a body transceiver positioned within the body; and
a wheel transceiver positioned within the steering wheel, wherein the body transceiver and the wheel transceiver are configured to communication with each other wirelessly.

13. The motor vehicle of claim 12 wherein the body transceiver and the wheel transceiver are configured to communication with visible light.

14. The motor vehicle of claim 12 wherein the body transceiver and the wheel transceiver are configured to communication with a short range radio frequency protocol.

15. A motor vehicle comprising:
a steering wheel;
a body;
a wheel shaft connected to the steering wheel and to the body such that the steering wheel is rotationally connected to the body;
a wheel transceiver positioned in the steering wheel; and
a body transceiver positioned in the body, wherein the body transceiver and the wheel transceiver are configured to wirelessly communicate with each other.

16. The motor vehicle of claim 15 wherein the body transceiver and the wheel transceiver are configured to communication with each other using visible light.

17. The motor vehicle of claim 15 further comprising:
a wheel actuator positioned on the steering wheel, wherein the wheel actuator is configured to send a control signal to a vehicle component located on the body, wherein the wheel actuator is free of an electrical connection with the vehicle component.

18. A method of producing a motor vehicle comprising:
attaching a steering wheel to a body, wherein the body comprises a body power coil, the steering wheel comprises a wheel power coil, and the body power coil and the wheel power coil are configured to transfer electrical power from the body power coil to the wheel power coil by magnetic resonance coupling.

19. The method of claim 18 further comprising:
forming a body impedance coil in the body; and
forming a wheel impedance coil in the steering wheel.

20. The method of claim 18 further comprising:
forming a vehicle component in the body; and
forming a wheel actuator in the steering wheel, wherein the wheel actuator is configured to wirelessly send a control signal to the vehicle component.
